(19) United States
(12) Patent Application Publication
(10) Pub. No.: US 2024/0371551 A1
(43) Pub. Date: Nov. 7, 2024

(54) SM-FE-N-BASED MAGNETIC POWDER AND METHOD FOR MANUFACTURING SAME

(71) Applicant: DOWA HOLDINGS CO., LTD., Tokyo (JP)

(72) Inventors: Tomoya YAMADA, Tokyo (JP); Takahiro YAMADA, Tokyo (JP); Kimitaka SATO, Tokyo (JP); Shogo KATO, Tokyo (JP); Shoichi KUMON, Tokyo (JP)

(21) Appl. No.: 18/686,941

(22) PCT Filed: Oct. 4, 2022
(86) PCT No.: PCT/JP2022/037132

§ 371 Date: Feb. 27, 2024

(30) Foreign Application Priority Data
Oct. 11, 2021 (JP) 2021-166847
Jul. 25, 2022 (JP) 2022-117996

(51) Int. Cl. H01F 1/059; B22F 9/08

(52) U.S. Cl. CPC H01F 1/059; B22F 9/082; B22F 2009/0824; B22F 2201/02; B22F 2301/355; B22F 2304/10

(57) ABSTRACT

An Sm—Fe—N-based magnetic powder includes particles containing Sm, Fe, and N as main components. The powder has a composition wherein a molar ratio of Sm to Fe (Sm/Fe) is 0.09 or more and 0.25 or less, a molar ratio of N to Fe (N/Fe) is 0.06 or more and 0.30 or less, and a Ca content in the powder is 0.002 mass % or less. When a cumulative 10% particle diameter is represented by D10, a cumulative 50% particle diameter is represented by D50, and a cumulative 90% particle diameter is represented by D90 in a volume-based particle size distribution according to a laser diffraction/scattering method, D50 is 2.0 to 11.0 μm, and D10, D50, and D90 satisfy a relationship of the following formula: (D90−D10)/D50<1.10. The Sm—Fe—N-based magnetic powder is advantageous in improving coercive force, containing few impurities, and improving the performance and manufacturability of a bonded magnet.

### TECHNICAL FIELD

The present invention relates to an Sm—Fe—N-based magnetic powder and a method for manufacturing the same.

### BACKGROUND ART

It is known that a substance in which N is introduced into an Sm₂Fe₁₇ intermetallic compound (a representative composition formula is Sm₂Fe₁₇N₃) is a ferromagnetic substance exhibiting excellent hard magnetism. In the present specification, a powder that is a powder of a substance obtained by introducing N into an Sm—Fe-based alloy having a stoichiometric composition of Sm₂Fe₁₇ or a peripheral composition thereof, and that is a ferromagnetic substance is referred to as “Sm—Fe—N-based magnetic powder”. The Sm—Fe—N-based magnetic powder is useful as a material for a bonded magnet. In the future, in order to respond to an increase in the performance of an automobile motor or a sensor, a bonded magnet obtained using an Sm—Fe—N-based magnetic powder is expected to have further improved magnetic properties such as an improved coercive force and improved residual magnetization.

Known techniques for manufacturing an Sm—Fe—N-based magnetic powder include a method employing a gas atomization method and a method employing a reduction diffusion method using Ca or the like as a reducing agent.

For example, PTL 1 describes that spherical particles of an Sm₂Fe₁₇ alloy are synthesized by a gas atomization method, and the obtained powder is subjected to a nitriding treatment in a tubular furnace, thereby obtaining an alloy powder having an Sm₂Fe₁₇N₃ composition. The average particle diameter of the particles obtained by a gas atomization method is 110 μm (paragraph 0012) or 80 μm (paragraph 0014).

PTL 2 describes an example in which a magnetic powder having a composition aimed at increasing a coercive force by adding an element such as Si to an Sm—Fe-based or Sm—Fe—C-based alloy is synthesized by an atomization method using gas spraying, gas-water spraying, and water spraying. An Sm—Fe—(C)—Si—N-based powder is obtained by subjecting the obtained particles to a nitriding treatment. The particle diameter is about 80 to 110 μm (Paragraph 0019).

PTL 3 describes that spherical particles of an Sm₂Fe₁₇ alloy having a particle diameter of 30 μm or less (page 16, line 3) can be obtained by a gas atomization method, and an SmFeN magnetic alloy can also be obtained by subjecting the spherical particles to a nitriding treatment (page 15, lines 24-25). In addition, it is described that a fine powder of an Sm₂Fe₁₇N alloy having a substantially spherical outer shape with a particle diameter of 30 μm or less (page 16, line 3) is obtained by colliding a jet stream of N₂ gas with a molten alloy of Sm₂Fe₁₇ in a gas atomization method (page 22, lines 2-8). It is said that an ultrafine powder having a particle diameter of 2 to 10 μm can be obtained by devising the method of spraying N₂ gas (page 22, lines 20-27).

On the other hand, PTLs 4 to 9 describe a method for obtaining an Sm—Fe—N-based magnetic powder by a reduction diffusion method using Ca or the like as a reducing agent and a nitriding treatment. With the use of the reduction diffusion method, a fine powder having a particle diameter of about 10 μm or less can be obtained, but the particles generally have a shape with considerable unevenness, and it is not always easy to synthesize spherical particles. In addition, remaining of Ca, which is a reducing agent component, cannot be avoided in the obtained Sm—Fe—N-based magnetic powder.

PTL 10 discloses a technique for improving the circularity of an Sm—Fe—N-based magnetic powder particles obtained using a raw material powder synthesized by a precipitation method for depositing an insoluble salt in water when an Sm—Fe—N-based magnetic powder is obtained using a reduction diffusion method and a nitriding treatment. It is said that the particle shape of the precipitate particles exhibiting a spherical shape is inherited to an alloy powder as a final product (paragraphs 0018 and 0037).

PTL 11 discloses a technique for obtaining a powder having an average particle diameter of 5 μm or less without using a crushing step at all by adopting a step of performing a reduction reaction in two steps when a magnetic powder such as an Sm—Fe—N-based magnetic powder is obtained using a reduction diffusion method and a nitriding treatment. With respect to a powder after having undergone the second reduction step, it is described that “after washing with water, calcium is thoroughly separated using a weak acid such as acetic acid”. Nevertheless, Ca remains at 0.01 wt % in powders obtained in Examples (paragraphs 0034, 0037, 0047, 0050, and 0060).

### CITATION LIST

### Patent Literature

PTL 1: JPH07-11307A
PTL 2: JP2001-68315A
PTL 3: WO02/00379A
PTL 4: JP2006-291257A
PTL 5: JP2018-31053A
PTL 6: JP2017-226885A
PTL 7: JP2010-270379A
PTL 8: JP2010-70777A
PTL 9: JP2007-119909A
PTL 10: JP2004-115921A
PTL 11: JPH11-310807A

### SUMMARY OF INVENTION

### Technical Problem

It is considered to be important for improving the performance of a bonded magnet that a magnetic powder used as a material for the bonded magnet should be formed of fine particles having a particle diameter as close as possible to a critical particle diameter to have a single magnetic domain, have a sharp particle size distribution with little variation in particle diameter, and have a low content of non-magnetic components. It is also effective in improving the performance of a bonded magnet that the particle shape is as close to spherical as possible.

With the use of the gas atomization method, powder particles having a nearly spherical shape can be synthesized. However, in the case of an Sm—Fe-based alloy, there is a problem that Sm in a molten metal easily reacts with a refractory material made of a ceramic. Therefore, it is difficult to industrially stably obtain an Sm—Fe alloy powder having an Sm/Fe molar ratio close to a target composition by a conventionally known gas atomization method. For example, a refractory material that forms a molten metal discharge nozzle or a stopper reacts with Sm, and nozzle clogging occurs and discharge is likely to become impossible. Conventionally, alumina (Al₂O₃) is generally often used as a refractory material of a crucible or a molten metal ejection nozzle of a gas atomizer. In particular, when a molten metal discharge nozzle or a stopper is made of alumina, a highly viscous Sm—Al—Fe—O-based compound is generated, and nozzle clogging is likely to occur. In addition, even if discharge is possible, the Sm content in the obtained powder is greatly reduced, or a reaction product is mixed as an impurity, and a deviation from a target composition is likely to occur. A compositional deviation causes a decrease in coercive force. The critical particle diameter at which Sm₂Fe₁₇ becomes a single magnetic domain is considered to be about 1 μm, but the particle diameter of the Sm—Fe alloy powder obtained by a gas atomization method disclosed in PTLs 1 and 2 is as big as about 80 to 110 μm.

It is said that with the use of the gas atomizer disclosed in PTL 3, an Sm—Fe alloy powder having a particle diameter of about 30 μm or less is obtained, and an Sm—Fe—N-based magnetic powder having a particle diameter of 2 to 10 μm is directly obtained by using N₂ as the cooling gas and devising the gas spraying method. However, in the particles obtained using N₂ gas in the atomization step, the nitrided state tends to become non-uniform, and it is difficult to directly synthesize an Sm—Fe—N-based magnetic powder in which the nitrided state of individual particles is uniform by a gas atomization method. Non-uniformity in the properties of individual particles is a negative factor in improving magnetic properties. In addition, there is no teaching where the reactivity with Sm is taken into account with respect to the refractory material of the crucible or the molten metal discharge nozzle in PTL 3. Even in the Examples, an example of synthesizing an Nd—Fe—B-based powder is shown, but an example of specifically synthesizing a powder containing Sm is not shown. If an attempt is made to synthesize an Sm—Fe—N-based magnetic powder having a particle diameter of 2 to 10 μm using a gas atomization method by spraying N₂ gas described in PTL 3, even if particles can be synthesized, it is considered to be extremely difficult to obtain an Sm—Fe—N-based magnetic powder with little variation in particle diameter, a good yield of Sm, and few impurities.

On the other hand, with the use of the reduction diffusion method using Ca or the like as a reducing agent and the nitriding treatment, it is possible to obtain an Sm—Fe—N-based magnetic powder formed of fine particles. Above all, it is said that with the use of the method characteristic of the raw material powder manufacturing technique disclosed in PTL 10, a spherical Sm—Fe—N-based magnetic powder can be obtained, and with the use of the method characteristic of a double reduction method disclosed in PTL 11, an Sm—Fe—N-based magnetic powder having a fine particle diameter can be obtained without going through a crushing step. However, even if the techniques of PTLs 10 and 11 are used, remaining of a reducing agent component such as Ca, another alkaline earth metal, or an alkali metal cannot be avoided. An alkaline earth metal or an alkali metal remaining in the magnetic powder is easy to gel a resin when a bonded magnet is manufactured using the powder as a material, which is a factor in lowering the manufacturability of the bonded magnet.

An object of the invention is to provide an Sm—Fe—N-based magnetic powder that is formed of fine-sized particles advantageous for improving a coercive force, that contains few impurities, and that is useful for improving the performance and manufacturability of a bonded magnet. Another object of the invention is to provide a manufacturing technique that is advantageous for obtaining an Sm—Fe—N-based magnetic powder having particularly high homogeneity.

### Solution to Problem

The above-mentioned objects are achieved by an Sm—Fe—N-based magnetic powder having a specific particle size distribution that contains no coarse particles and having an extremely low Ca content. In addition, in order to obtain a homogeneous magnetic powder in which the degree of nitriding of individual particles is as uniform as possible, it is extremely effective that an Sm—Fe-based alloy powder adjusted to have a particle size distribution with a sufficiently small variation in particle diameter is subjected to a nitriding treatment. The following inventions are disclosed in the present specification.
[1] An Sm—Fe—N-based magnetic powder, including particles containing Sm, Fe, and N as main components, in which the powder has a composition in which a molar ratio of Sm to Fe (Sm/Fe) is 0.09 or more and 0.25 or less, a molar ratio of N to Fe (N/Fe) is 0.06 or more and 0.30 or less, and a Ca content in the powder is 0.002 mass % or less, and when a cumulative 10% particle diameter is represented by D10, a cumulative 50% particle diameter is represented by D50, and a cumulative 90% particle diameter is represented by D90 in a volume-based particle size distribution according to a laser diffraction/scattering method, D50 is 2.0 to 11.0 μm, and D10, D50, and D90 satisfy a relationship of the following formula (1):

$$( D 90 - D 10 ) / D 50 \leq 1.1 . \qquad ( 1 )$$

[2] The Sm—Fe—N-based magnetic powder according to the above [1], in which D10 is 2.0 μm or more and D90 is 17.0 μm or less.
[3] The Sm—Fe—N-based magnetic powder according to the above [1] or [2], in which a total content of Sm, Fe, and N in the powder is 95 mass % or more.
[4] The Sm—Fe—N-based magnetic powder according to any of the above [1] to [3], in which the Ca content in the powder is 0.001 mass % or less.
[5] The Sm—Fe—N-based magnetic powder according to any of the above [1] to [4], in which the particles forming the powder have an average circularity of 0.80 or more,
in which the average circularity corresponds to an arithmetic mean of the circularity of each particle determined from an SEM (scanning electron microscope) image by the following formula (2):

$$circularity = 4 Π S / {L}^{2} \qquad ( 2 )$$

where π denotes the circle ratio, S denotes an area of a measurement target particle on the image (μm²), and L denotes a perimeter of the particle on the image (μm).
[6] A method for manufacturing the Sm—Fe—N-based magnetic powder according to any of the above [1] to [5], including:
a gas atomization step of obtaining an Sm—Fe-based powder in which a molar ratio of Sm to Fe (Sm/Fe) is 0.09 or more and 0.25 or less, and a cumulative 50% particle diameter D50 in a volume-based particle size distribution according to a laser diffraction/scattering method is 25.0 μm or less by a gas atomization method in which in an atmosphere of an inert gas excluding nitrogen, a gas stream of the inert gas excluding nitrogen is sprayed onto a molten metal containing Sm and Fe as main components, thereby rapidly cooling and solidifying particles of the molten metal;
a classification step of obtaining a powder having a particle size distribution in which a cumulative 10% particle diameter D10, a cumulative 50% particle diameter D50, and a cumulative 90% particle diameter D90 in a volume-based particle size distribution according to a laser diffraction/scattering method satisfy a relationship of the above formula (1) by sieving particles of the powder obtained in the gas atomization step; and
a nitriding step of subjecting the powder obtained in the classification step to a nitriding treatment by heating and holding the powder in a temperature range of 500° C. or lower in a non-oxidizing gas atmosphere containing a nitrogen compound.
[7] The method for manufacturing the Sm—Fe—N-based magnetic powder according to the above [6], in which, in the gas atomization step, the Sm—Fe-based powder having a Ca content of 0.002 mass % or less is obtained.
[8] The method for manufacturing the Sm—Fe—N-based magnetic powder according to the above [6] or [7], in which, in the gas atomization step, the Sm—Fe-based powder in which the particles have an average circularity of 0.80 or more is obtained,
in which the average circularity corresponds to an arithmetic mean of the circularity of each particle determined from an SEM (scanning electron microscope) image by the above formula (2).
[9] The method for manufacturing the Sm—Fe—N-based magnetic powder according to any of the above [6] to [8], in which, in the classification step, the Sm—Fe-based powder in which in the volume-based particle size distribution according to a laser diffraction/scattering method, the cumulative 10% particle diameter D10 is 2.0 μm or more and the cumulative 90% particle diameter D90 is 17.0 μm or less is obtained.

### Advantageous Effects of Invention

The Sm—Fe—N-based magnetic powder according to the invention is formed of fine spherical particles with a small variation in particle diameter, and has an extremely low Ca content. This powder includes finer particles and exhibits superior uniformity in particle diameter and nitriding as compared with a conventional Sm—Fe—N-based magnetic powder obtained using a gas atomization method, therefore, an effect of improving the coercive force as compared with the case of the same composition or an effect of making the magnetic properties uniform is expected. In addition, the content of impurities such as an alkaline earth metal is extremely low as compared with a conventional Sm—Fe—N-based magnetic powder obtained using a reduction diffusion method, which is advantageous for preventing gelation of a resin when a bonded magnet is manufactured. The invention contributes to improving both performance and manufacturability of a bonded magnet obtained using an Sm—Fe—N-based magnetic powder.

### BRIEF DESCRIPTION OF DRAWINGS

FIG. 1 is a view schematically illustrating a structure of a gas atomizer.

FIG. 2 is a view schematically showing an example of a cross-sectional structure of a portion near the bottom of a crucible of the gas atomizer.

FIG. 3 is an SEM image (backscattered electron image) of a sample in which cross sections of particles of an Sm—Fe—N-based powder obtained in Example 1 appear.

### DESCRIPTION OF EMBODIMENTS

### [Composition]

The invention is directed to an “Sm—Fe—N-based magnetic powder” which is a powder of a substance obtained by introducing N into an Sm—Fe-based alloy having a stoichiometric composition of Sm₂Fe₁₇ or a peripheral composition thereof. The Sm/Fe molar ratio of Sm₂Fe₁₇ is about 0.12. It is considered that in the Sm—Fe-based alloy, the closer the Sm/Fe molar ratio is to the stoichiometric composition of Sm₂Fe₁₇, the more advantageous it is in terms of magnetic properties, but ferromagnetism is exhibited even in a peripheral composition range thereof. Here, the molar ratio of Sm to Fe (Sm/Fe) is specified in a range of 0.09 or more and 0.25 or less in consideration of ensuring a coercive force effective as a material for a bonded magnet.

The introduction of a nitrogen atom into Sm₂Fe₁₇ increases the Curie point, so that a practical magnetic material can be formed. The nitrogen atom occupies an interstitial position in the Sm₂Fe₁₇ crystal lattice. A representative composition of a conventionally known Sm—Fe—N-based magnetic powder is Sm₂Fe₁₇N₃. The N/Fe molar ratio of Sm₂Fe₁₇N₃ is about 0.18. Here, the molar ratio of N to Fe (N/Fe) is specified in a range of 0.06 or more and 0.30 or less in consideration that a coercive force effective as a material for a bonded magnet is stably obtained in a temperature range including normal temperature.

An alkaline earth metal and an alkali metal have an effect of gelling a resin used in a bonded magnet. Magnetic orientation is usually performed in a step of manufacturing a bonded magnet. It is advantageous for improving the manufacturability and performance of a bonded magnet that an Sm—Fe—N-based magnetic powder in which the content of an alkaline earth metal or an alkali metal is as small as possible is applied. In the invention, the Ca content in the powder is specified to be 0.002 mass % or less (20 ppm or less) as a range in which the reactivity with the resin forming the bonded magnet is extremely low. A powder in which the Ca content is 0.001 mass % or less (10 ppm or less) is a more preferred target. Here, it does not matter if Ca is not contained in the powder. That is, the composition range that “the Ca content is 0.002 mass % or less” or “the Ca content is 0.001 mass % or less” includes a case where the Ca content is 0 mass %. The total amount of alkaline earth metals including Ca in the powder is desirably 0.003 mass % or less (including a case of 0 mass %). Further, the total amount of Na and other alkali metals in the powder is desirably 0.003 mass % or less (including a case of 0 mass %).

From the viewpoint of ensuring high magnetization (saturation magnetization, residual magnetization), the total content of Sm, Fe, and N in the Sm—Fe—N-based magnetic powder is preferably 95 mass % or more.

### [Particle Diameter]

Hereinafter, in this specification, unless otherwise specified, D10, D50, and D90 mean a cumulative 10% particle diameter, a cumulative 50% particle diameter, and a cumulative 90% particle diameter, respectively, in a volume-based particle size distribution according to a laser diffraction/scattering method.

It is considered that a critical particle diameter at which Sm₂Fe₁₇ becomes a single magnetic domain is about 1 μm. When the particle diameter approaches the critical particle diameter, the particle becomes a magnetic particle with a single magnetic domain structure and a high coercive force is obtained. However, in the Sm—Fe—N-based magnetic powder for a bonded magnet, when the average particle diameter is reduced to about 1 μm, for example, problems such that the packing property of particles when a bonded magnet is produced deteriorates, adhesion and aggregability between particles increase, the particles become more susceptible to the effect of moisture in the air, the magnetization direction becomes unstable due to thermal fluctuation, and the coercive force decreases are likely to occur. Here, a powder having a D50 of 2.0 μm or more is targeted as a practical particle diameter size. As the average particle diameter increases, the number of magnetic domains forming a multi-magnetic domain structure in one crystal grain increases, and the coercive force decreases. In consideration of maintaining an excellent coercive force, the upper limit of D50 is specified here to be 11.0 μm.

In order to improve the performance of a bonded magnet, it is desirable that the variation in particle diameter of magnetic particles used therefor is small. In particular, even if the average particle diameter is as small as, for example, about 11 μm or less, when the particles have a particle size distribution with a large mixing ratio of coarse particles, it is difficult that the original high coercive force obtained by being fine particles is sufficiently exhibited. In the invention, it is specified that the particles have a particle size distribution that satisfies the following formula (1).

$$( D 90 - D 10 ) / D 50 \leq 1.1 \qquad ( 1 )$$

In particular, it is more preferred that D10 is 2.0 μm or more and D90 is 17.0 μm or less.

### [Particle Shape]

The magnetic powder used for a bonded magnet is magnetically oriented in a resin, therefore, it is desirable that the shape of the particles is as spherical as possible. Specifically, the average circularity of the particles forming the powder is preferably 0.80 or more. The average circularity can be determined by the following method.

### (Method for Determining Average Circularity)

A sample in which the cross sections of particles appear is prepared by embedding a powder which is a measurement target in a resin followed by polishing. The sample is observed with an SEM (scanning electron microscope), and in an SEM image for a randomly selected field of view, all particles for which the entire outline of the cross section of the particle can be ascertained are defined as measurement target particles. For each measurement target particle, the circularity is determined by the following formula (2).

$$circularity = 4 Π S / {L}^{2} \qquad ( 2 )$$

Here, π denotes the circle ratio, S denotes an area of a measurement target particle on the image (μm²), and L denotes a perimeter of the particle on the image (μm).

The measurement of the circularity is performed with an SEM image for one or more randomly selected fields of view so that the total number of measurement target particles is 500 or more, and a value obtained by dividing the sum of the circularities of individual particles by the total number of measurement target particles is defined as the average circularity of the particles forming the powder.

### [Manufacturing Method]

The above-mentioned Sm—Fe—N-based magnetic powder can be manufactured by a procedure in which a gas atomization method, a classification treatment, and a nitriding treatment are combined. The method is disclosed below.

### [Gas Atomization Step]

Conventionally, an attempt has been made to synthesize an Sm—Fe-based powder by a gas atomization method (for example, PTLs 1 to 3). However, Sm easily reacts with a ceramic of an apparatus used in the gas atomization method, and it is difficult to industrially directly synthesize a fine powder with a predetermined target composition while maintaining a high yield of Sm by a conventionally known gas atomization method. Besides Sm, Nd is exemplified as a representative rare earth element used in a magnet material. According to an Ellingham diagram, Sm is comparable to Nd in terms of susceptibility to oxidation. However, when a molten metal containing Sm or Nd is actually produced and the reactivity with a ceramic is compared, the reactivity of the Sm-containing alloy is higher, and the difficulty in industrially smelting the alloy is higher. A possible reason for this is considered to be that Sm has a higher vapor pressure than Nd at the same temperature.

The inventors studied the reactivity between a molten metal of an Sm—Fe-based alloy and a ceramic by an experiment, and repeatedly investigated the configuration of an apparatus suitable for directly synthesizing a powder of an Sm—Fe-based alloy with a target composition by a gas atomization method. As a result, it was verified that an Sm—Fe-based alloy powder having a particle diameter such that D50 is 25.0 μm or less can be synthesized with a high Sm yield in a gas atomizer provided with a “crucible” for producing a molten metal, a “molten metal discharge nozzle member” for discharging the molten metal into a gas phase space attached to the bottom of the crucible, and a movable “stopper” that can come into contact with and separate from the molten metal discharge nozzle member, by forming the crucible, the molten metal discharge nozzle member, and at least a portion of the stopper that comes into contact with the molten metal with boron nitride (BN) or yttrium oxide (Y₂O₃), and using an inert gas excluding nitrogen as the atmospheric gas in the gas phase space and as the cooling gas. If an Sm—Fe-based alloy powder having a D50 of 25.0 μm or less can be synthesized by a gas atomization method, Sm—Fe-based alloy particles having a D50 in a range of 2.0 to 11.0 μm can be sufficiently sorted by classification described later. It is also quite possible to synthesize an Sm—Fe-based alloy powder having a particle diameter such that D50 is 20.0 μm or less. Here, in each of the respective members of the crucible, the molten metal discharge nozzle member, and the stopper, a ceramic that forms a portion to come into contact with the molten metal need only to be boron nitride (BN) or yttrium oxide (Y₂O₃). For example, a coating method for the surface of an apparatus made of aluminum oxide (Al₂O₃) with a ceramic of boron nitride (BN) or yttrium oxide (Y₂O₃) may be applied. Examples of the coating method include thermal spraying.

In an atmosphere of an inert gas excluding nitrogen (for example, argon gas), particles of a molten metal containing Sm and Fe as main components are rapidly cooled and solidified by spraying a gas stream of the inert gas excluding nitrogen (for example, argon gas) onto the molten metal using a gas atomizer having the above-mentioned apparatus configuration, whereby an Sm—Fe-based powder in which the molar ratio of Sm to Fe (Sm/Fe) is 0.09 or more and 0.25 or less, and D50 is 25.0 μm or less is obtained. The total content of Sm and Fe in the molten metal is preferably 95 mass % or more, and more preferably 98 mass % or more. The composition of the molten metal smelted in the crucible can be made substantially the same as the metal component composition of the target Sm—Fe—N-based magnetic powder. The temperature of the molten metal at the time of discharge may be set, for example, in a range of 1400 to 1900° C. In this manner, a powder of an Sm—Fe-based alloy in which the particles have an average circularity of 0.80 or more can be obtained. With the use of a raw material that does not contain Ca or has an extremely low Ca content, a powder of an Sm—Fe-based alloy with a Ca content of 0.002 mass % or less (including a case of 0 mass %) can be synthesized. It is also quite possible to synthesize a powder having a Ca content of 0.001 mass % or less (including a case of 0 mass %).

### [Classification Step]

Subsequently, the Sm—Fe-based alloy powder synthesized by the gas atomization method is collected and classified by sieving. At this stage, the particle size distribution is adjusted beforehand so that D50 is 2.0 to 11.0 μm and the following formula (1) is satisfied.

$$( D 90 - D 10 ) / D 50 \leq 1.1 \qquad ( 1 )$$

In particular, it is more preferred to adjust the particle size distribution beforehand so that the above formula (1) is satisfied and “D10 is 2.0 μm or more and D90 is 17.0 μm or less”.

It is important to perform this classification operation before a nitriding treatment. The Sm—Fe alloy particles removed by the classification operation can be reused as part of the raw material alloy to be subjected to the gas atomization method.

The method of the classification operation includes a manual method using a sieve, a method using an ultrasonic sieve, and the like. When the classification operation is performed by applying ultrasonic vibration to a sieve using an ultrasonic sieve, even in a case of a powder containing fine particles, for example, having a particle diameter of 20 μm or less, clogging can be easily avoided, and the classification operation can be performed more easily.

### [Nitriding Step]

The Sm—Fe-based alloy powder whose particle size distribution has been adjusted by the above-mentioned classification step is subjected to a nitriding treatment. Since the particle size distribution has been adjusted so as to have little variation in particle diameter, the degree of nitriding of each particle can be made uniform. The nitriding treatment can be performed by holding the heated powder in a non-oxidizing gas atmosphere containing a nitrogen compound gas. The heating temperature is desirably set to 500° C. or lower so that the intermetallic compound phase forming the Sm—Fe alloy is not decomposed. If the temperature is too low, it takes a long time for nitriding to proceed, which is disadvantageous in diffusing nitrogen atoms uniformly into the interior of the intermetallic compound. The heating temperature is preferably set to 300° C. or higher.

As the atmospheric gas for the nitriding treatment, it is practical to use a reducing atmosphere containing a mixed gas of ammonia (NH₃) and hydrogen (H₂). For example, the mixing ratio of ammonia and hydrogen (NH₃:H₂) can be set in a range of 10:90 to 60:40. Other examples of the atmospheric gas used for the nitriding treatment include a mixed gas of hydrogen, ammonia, and nitrogen (N₂), a mixed gas of hydrogen, ammonia, and argon (Ar), ammonia alone, a mixed gas of ammonia and nitrogen, a mixed gas of ammonia and argon, nitrogen alone, and a mixed gas of nitrogen and hydrogen, and a reducing atmosphere can be formed using these. The optimum time for the nitriding treatment slightly varies depending on the average particle diameter of the powder, the composition of the atmospheric gas, and the temperature, but usually the optimum time can be found in a range of 15 to 240 minutes.

### EXAMPLES

### Example 1

### (Synthesis of Sm—Fe Alloy Powder by Gas Atomization Method)

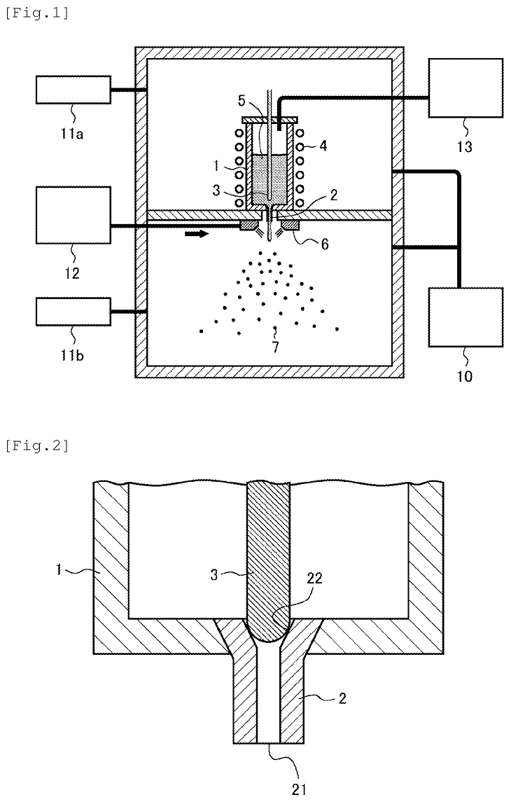

FIG. 1 schematically shows a configuration of a gas atomizer used in this example. Inside the chamber, there are two independent upper and lower spaces that can be evacuated by a vacuum evacuation apparatus 10, and these spaces can be made to serve as gas phase spaces each having a predetermined gas atmosphere by introducing a gas from an atmospheric gas supply source 11a or 11b. In the upper space, a crucible 1 is placed, and a raw material is melted by induction heating with a high-frequency coil 4 to form a molten metal 5 therein. A molten metal discharge nozzle member 2 for discharging the molten metal 5 into the lower gas phase space is attached to the bottom of the crucible 1. A molten metal flow path is closed by pressing a stopper 3 against the molten metal discharge nozzle member 2 until the molten metal 5 is discharged. After the molten metal 5 is sufficiently homogenized and the molten metal at a predetermined temperature is obtained, the stopper 3 is pulled up in a state where a gas at a predetermined pressure is supplied from a molten metal discharging gas supply apparatus 13 to the surface of the molten metal in the crucible 1, and the molten metal 5 is discharged from the tip of the molten metal discharge nozzle member 2 into the lower gas phase space. The lower gas phase space is equipped with a cooling gas injection nozzle 6 for spraying a cooling gas onto the discharged molten metal 5. Before discharge is started, the supply of the cooling gas from a cooling gas supply apparatus 12 to the cooling gas injection nozzle 6 is started, and the cooling gas is injected at a high pressure from the cooling gas injection nozzle 6. By applying a strong jet stream of this cooling gas to the molten metal 5, fine particles of the molten metal 5 are formed and the fine particles are rapidly cooled and solidified. Solidified metal particles 7 deposit at the bottom of the lower gas phase space.

FIG. 2 schematically shows an example of a cross-sectional structure of a portion near the bottom of the crucible of the gas atomizer. The molten metal discharge nozzle member 2 attached to the bottom of the crucible 1 has a discharge port 21 which is an opening at the tip of the nozzle and a stopper contact surface 22. The stopper 3 is of a movable type and moves vertically and has a function of closing the flow path of the nozzle by coming into contact with the stopper contact surface 22 of the molten metal discharge nozzle member 2, and opening the flow path of the nozzle by separating from the stopper contact surface 22 when the molten metal is discharged.

In this example, the entire crucible 1 was made of boron nitride (BN), the entire molten metal discharge nozzle member 2 was made of boron nitride (BN), and at least the entire portion of the stopper 3 to be immersed in the molten metal 5 was made of yttrium oxide (Y₂O₃). The inner diameter of the nozzle of the molten metal discharge nozzle member 2 was set to 3.0 mm.

As the raw material, previously smelted Sm—Fe alloy fragments were used. As a result of an analysis, the Sm/Fe molar ratio of this raw material alloy was 0.16, and the Ca content in the raw material alloy was 0.002 mass %. In the crucible, 996.7 g of this raw material was placed and melted by high-frequency induction heating in an Ar atmosphere. After the raw material alloy was transformed into a completely molten state, the molten metal at 1637° C. was discharged from the nozzle into the lower gas phase space when 27 minutes had passed since the start of heating. Hereinafter, discharging the molten metal in the crucible from the nozzle may be referred to as “tapping”. In this example, the entire amount of the molten metal in the crucible could be tapped. The maximum supply pressure of the molten metal discharging gas at the time of tapping was set to 65 kPa in terms of a pressure difference from the atmospheric gas pressure. As the cooling gas, Ar was used. In addition, the lower gas phase space was also made to have an Ar atmosphere. All the obtained powder was collected.

The powder obtained by the gas atomization method was heated and dissolved with hydrochloric acid, diluted, and then analyzed with an ICP optical emission spectrometer (Agilent 720 manufactured by Agilent Technologies, Inc.). As a result, the Sm/Fe molar ratio was 0.16, which was equivalent to that of the raw material alloy. The content of each element in the powder is shown in Table 1. The Ca content was less than 0.001% (the measurement limit or less) It was verified that this powder is an Sm—Fe-based alloy.

The particle size distribution of the Sm—Fe-based alloy powder obtained by the gas atomization method was measured with a laser diffraction particle size distribution analyzer (Microtrac HRA manufactured by Nikkiso Co., Ltd.). As a result, the cumulative 50% particle diameter D50 was 18.89 μm in the volume-based particle size distribution according to the laser diffraction/scattering method. The values of the cumulative particle diameters D10 to D90 in 10% increments, and the cumulative 95% particle diameter D95 are shown in Table 2. The value of (D90−D10)/D50, which is the left side of the above formula (1), was 2.77.

### (Classification)

The Sm—Fe-based alloy powder obtained by the gas atomization method was classified with an ultrasonic sieving machine equipped with a sieve with an opening of 16 μm to remove particles having a large particle diameter. The analytical composition determined in the same manner as described above for the Sm—Fe-based alloy powder after classification is shown in Table 1. Further, when the volume-based particle size distribution according to the laser diffraction/scattering method was determined in the same manner as described above, the cumulative 50% particle diameter D50 was 10.82 μm. The values of the cumulative particle diameters D10 to D90 in 10% increments, and the cumulative 95% particle diameter D95 are shown in Table 2. As a result of classification, the value of (D90−D10)/D50, which is the left side of the above formula (1), was 0.97, and an Sm—Fe-based alloy powder that satisfies the above formula (1) and has little variation in particle diameter could be prepared.

This powder was observed with an SEM (scanning electron microscope). Based on the image, the average circularity determined by the method according to the above-mentioned “Method for Determining Average Circularity” was 0.82. The circularity variance σ² was 0.03.

### (Nitriding)

The nitriding treatment was performed by charging the Sm—Fe-based alloy powder sorted by the classification into a tubular furnace and exposing the powder to a reducing mixed gas with a composition of 35 vol % of ammonia (NH₃) and 65 vol % of hydrogen (H₂) in a state where the temperature was raised to 420° C. for 60 minutes.

The analytical composition determined in the same manner as described above for the powder after the nitriding treatment is shown in Table 1. The Sm/Fe molar ratio was 0.17, which was substantially equivalent to that of the raw material alloy. Further, the N/Fe molar ratio was 0.19. The Ca content was less than 0.001% (the measurement limit or less). It was verified that this powder is an Sm—Fe—N-based powder.

When the volume-based particle size distribution according to the laser diffraction/scattering method was determined in the same manner as described above for the Sm—Fe—N-based powder after the nitriding treatment, the cumulative 50% particle diameter D50 was 10.39 μm. The values of the cumulative particle diameters D10 to D90 in 10% increments, and the cumulative 95% particle diameter D95 are shown in Table 2. The value of (D90−D10)/D50, which is the left side of the above formula (1), was 0.98. It was verified that this Sm—Fe—N-based powder satisfies the above formula (1) and is a powder having little variation in particle diameter.

The average circularity determined in the same manner as described above for the obtained Sm—Fe—N-based powder was 0.83. The circularity variance σ² was 0.02.

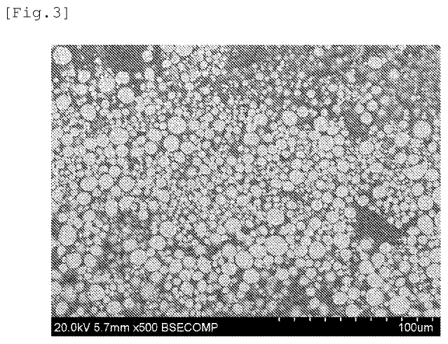

FIG. 3 illustrates an SEM image (backscattered electron image) of a sample in which cross sections of particles of this Sm—Fe—N-based powder appear. The length from the left end to the right end of 11 scale graduations shown in the lower right of the photograph corresponds to 100 μm.

### (Measurement of Magnetic Properties)

The magnetic properties of the Sm—Fe—N-based powder obtained by the nitriding treatment were measured with a VSM (DynaCool manufactured by Quantum Design, Inc.). The measurement conditions are as follows: maximum applied magnetic field: 2 T, sweep speed: 0.01 T/s, time constant: 1 s, amplitude: 2 mm, and frequency: 40 kHz. As a result of measurement, at a temperature of 300 K, the saturation magnetization was 87 A·m²/kg, the residual magnetization was 40 A·m²/kg, and the coercive force was 117.7 kA/m (1476 Oe).

It was verified that this Sm—Fe—N-based powder is a magnetic powder.

In this example, the Sm—Fe—N-based magnetic powder has a composition in which the Sm content is excessive with respect to the stoichiometric composition of Sm₂Fe₁₇, but exhibits a coercive force useful as a raw material for a bonded magnet. In comparison with the same composition, the Sm—Fe—N-based magnetic powder of this example is formed of finer particles than an Sm—Fe—N-based magnetic powder obtained using a conventionally known gas atomization method, and therefore, it is considered that the number of magnetic domains formed in the particles is reduced, so that a higher coercive force is exhibited. Since the Ca content is extremely low, the effect of gelling a resin of a bonded magnet is reduced as compared with an Sm—Fe—N-based magnetic powder obtained using a conventionally known reduction diffusion method. In addition, it was also verified that by devising a material of a ceramic member of a gas atomizer as described above, the reaction between Sm and the ceramic is prevented, and a fine Sm—Fe—N-based magnetic powder having an Sm/Fe molar ratio substantially equal to the composition of the raw material can be obtained.

TABLE 1
(Example 1)

| | Chemical composition | | |
|---|---|---|---|
| | After gas | After | After |
| | atomization | classification | nitriding |
| Element | (mass % ) | (mass % ) | (mass % ) |
| Sm | 30.4 | 30.2 | 29.6 |
| Fe | 68.8 | 68.2 | 63.5 |
| Al | 0.013 | 0.03 | 0.02 |
| O | 0.46 | 0.40 | 1.4 |
| N | 0.01 | <0.001 | 3.0 |
| Ca | <0.0010 | 0.0012 | <0.0010 |
| C | 0.016 | 0.033 | <0.001 |
| S | <0.001 | 0.001 | <0.001 |
| Y | 0.0185 | 0.0170 | 0.0141 |
| B | 0.0062 | <0.0050 | 0.0068 |

TABLE 2
(Example 1)

| | | Particle diameter | | |
|---|---|---|---|---|
| | Cumulative | After gas | After | After |
| | particle | atomization | classification | nitriding |
| Symbol | diameter | (μm) | (μm) | (μm) |
| D10 | 10% | 6.85 | 6.08 | 5.76 |
| D20 | 20% | 9.47 | 7.80 | 7.48 |
| D30 | 30% | 12.11 | 8.94 | 8.59 |
| D40 | 40% | 15.21 | 9.90 | 9.51 |
| D50 | 50% | 18.89 | 10.82 | 10.39 |
| D60 | 60% | 23.72 | 11.80 | 11.31 |
| D70 | 70% | 31.05 | 12.91 | 12.36 |
| D80 | 80% | 42.14 | 14.34 | 13.71 |
| D90 | 90% | 59.21 | 16.62 | 15.90 |
| D95 | 95% | 78.80 | 18.83 | 18.06 |

### Example 2

In this example, an attempt was made to manufacture an Sm—Fe—N-based magnetic powder under the same conditions as in Example 1 except that the Sm—Fe-based alloy powder obtained by the gas atomization method in Example 1 was classified using an ultrasonic sieving machine equipped with a sieve with an opening of 16 μm to remove particles having a large particle diameter, and thereafter, the obtained powder after classification was further classified using an ultrasonic sieving machine equipped with a sieve with an opening of 5 μm to remove particles having a large particle diameter, and the treatment temperature in the nitriding step was set to 400° C.

The analytical composition determined in the same manner as in Example 1 for the Sm—Fe-based alloy powder after classification is shown in Table 3. Further, when the volume-based particle size distribution according to the laser diffraction/scattering method was determined in the same manner as in Example 1, the cumulative 50% particle diameter D50 was 6.67 μm. The values of the cumulative particle diameters D10 to D90 in 10% increments, and the cumulative 95% particle diameter D95 are shown in Table 4. As a result of classification, the value of (D90−D10)/D50, which is the left side of the above formula (1), was 1.09, and an Sm—Fe-based alloy powder that satisfies the above formula (1) and has little variation in particle diameter could be prepared.

This powder was observed with an SEM (scanning electron microscope). Based on the image, the average circularity determined by the method according to the above-mentioned “Method for Determining Average Circularity” was 0.83. The circularity variance σ² was 0.03.

### (Nitriding)

The nitriding treatment was performed by charging the Sm—Fe-based alloy powder sorted by the classification into a tubular furnace and exposing the powder to a reducing mixed gas with a composition of 35 vol % of ammonia (NH₃) and 65 vol % of hydrogen (H₂) in a state where the temperature was raised to 400° C. for 60 minutes.

The analytical composition determined in the same manner as described above for the powder after the nitriding treatment is shown in Table 3. The Sm/Fe molar ratio was 0.17, which was substantially equivalent to that of the raw material alloy. Further, the N/Fe molar ratio was 0.19. The Ca content was less than 0.001% (the measurement limit or less). It was verified that this powder is an Sm—Fe—N-based powder.

When the volume-based particle size distribution according to the laser diffraction/scattering method was determined in the same manner as described above for the Sm—Fe—N-based powder after the nitriding treatment, the cumulative 50% particle diameter D50 was 6.27 μm. The values of the cumulative particle diameters D10 to D90 in 10% increments, and the cumulative 95% particle diameter D95 are shown in Table 4. The value of (D90−D10)/D50, which is the left side of the above formula (1), was 1.09. It was verified that this Sm—Fe—N-based powder satisfies the above formula (1) and is a powder having little variation in particle diameter.

The average circularity determined in the same manner as described above for the obtained Sm—Fe—N-based powder was 0.83. The circularity variance σ² was 0.02.

### (Measurement of Magnetic Properties)

The magnetic properties of the Sm—Fe—N-based powder obtained by the nitriding treatment were measured with a VSM (DynaCool manufactured by Quantum Design, Inc.). The measurement conditions are as follows: maximum applied magnetic field: 2 T, sweep speed: 0.01 T/s, time constant: 1 s, amplitude: 2 mm, and frequency: 40 kHz. As a result of measurement, at a temperature of 300 K, the saturation magnetization was 110 A·m²/kg, the residual magnetization was 24.9 A·m²/kg, and the coercive force was 38 kA/m (478 Oe). It was verified that this Sm—Fe—N-based powder is a magnetic powder.

TABLE 3
(Example 2)

| | Chemical composition | | |
|---|---|---|---|
| | After gas | After | After |
| | atomization | classification | nitriding |
| Element | (mass % ) | (mass % ) | (mass %) |
| Sm | 30.4 | 30.1 | 29.4 |
| Fe | 68.8 | 67.9 | 62.8 |
| Al | 0.013 | 0.035 | 0.022 |
| O | 0.46 | 0.38 | 1.5 |
| N | 0.01 | <0.001 | 3.0 |
| Ca | <0.0010 | <0.0010 | <0.0010 |
| C | 0.016 | 0.035 | <0.001 |
| S | <0.001 | <0.001 | <0.001 |
| Y | 0.0185 | 0.0158 | 0.0135 |
| B | 0.0062 | <0.0050 | 0.0069 |

TABLE 4
(Example 2)

| | | Particle diameter | | |
|---|---|---|---|---|
| | Cumulative | After gas | After | After |
| | particle | atomization | classification | nitriding |
| Symbol | diameter | (μm) | (μm) | (μm) |
| D10 | 10% | 6.85 | 4.05 | 3.73 |
| D20 | 20% | 9.47 | 4.91 | 4.59 |
| D30 | 30% | 12.11 | 5.54 | 5.19 |
| D40 | 40% | 15.21 | 6.10 | 5.71 |
| D50 | 50% | 18.89 | 6.67 | 6.27 |
| D60 | 60% | 23.72 | 7.30 | 6.81 |
| D70 | 70% | 31.05 | 8.06 | 7.51 |
| D80 | 80% | 42.14 | 9.16 | 8.53 |
| D90 | 90% | 59.21 | 11.33 | 10.59 |
| D95 | 95% | 78.80 | 14.15 | 13.38 |

### Comparative Example 1

In this example, an attempt was made to manufacture an Sm—Fe—N-based magnetic powder under the same conditions as in Example 1 except that in a gas atomizer having a configuration shown in FIGS. 1 and 2, the entire crucible 1 was made of aluminum oxide (Al₂O₃), the entire molten metal discharge nozzle member 2 was made of boron nitride (BN), and at least the entire portion of the stopper 3 to be immersed in the molten metal 5 was made of aluminum oxide (Al₂O₃), fragments of an Sm—Fe alloy in which the Sm/Fe molar ratio is 0.13 were used as the raw material, the amount of the raw material used was set to 622 g, the tapping temperature during gas atomization was set to 1660° C., and the molten metal was tapped when 25 minutes had passed since the start of heating.

Also in this case, the entire amount of the molten metal in the crucible could be tapped. However, when the composition analysis of the powder obtained by the gas atomization method was performed, the Sm/Fe molar ratio was 0.07, and an Sm—Fe-based alloy powder in which the yield of Sm with respect to the raw material alloy is significantly low was obtained. It is considered that the reason for the decrease in yield of Sm is that Sm in the molten metal reacted with the ceramic of the crucible or the stopper. The cumulative 50% particle diameter of the Sm—Fe—N-based magnetic powder obtained through the classification and the nitriding treatment was as fine as 12.7 μm, but since the composition was outside the specified range of the invention, the coercive force was 24.5 kA/m² (307 Oe), which is significantly lower than that of Example 1.

### REFERENCE SIGNS LIST

1: crucible
2: molten metal discharge nozzle member
3: stopper
4: high-frequency coil
5: molten metal
6: cooling gas injection nozzle
7: solidified metal particle
10: vacuum evacuation apparatus
11a, 11b: atmospheric gas supply source
12: cooling gas supply apparatus
13: molten metal discharging gas supply apparatus
21: discharge port
22: stopper contact surface

1. An Sm—Fe—N-based magnetic powder, comprising particles containing Sm, Fe, and N as main components, wherein the powder has a composition in which a molar ratio of Sm to Fe (Sm/Fe) is 0.09 or more and 0.25 or less, a molar ratio of N to Fe (N/Fe) is 0.06 or more and 0.30 or less, and a Ca content in the powder is 0.002 mass % or less, and when a cumulative 10% particle diameter is represented by D10, a cumulative 50% particle diameter is represented by D50, and a cumulative 90% particle diameter is represented by D90 in a volume-based particle size distribution according to a laser diffraction/scattering method, D50 is 2.0 to 11.0 μm, and D10, D50, and D90 satisfy a relationship of the following formula (1):
$$( D 90 - D 10 ) / D 50 \leq 1.1 . \qquad ( 1 )$$

2. The Sm—Fe—N-based magnetic powder according to claim 1, wherein D10 is 2.0 μm or more and D90 is 17.0 μm or less.

3. The Sm—Fe—N-based magnetic powder according to claim 1, wherein a total content of Sm, Fe, and N in the powder is 95 mass % or more.

4. The Sm—Fe—N-based magnetic powder according to claim 1, wherein the Ca content in the powder is 0.001 mass % or less.

5. The Sm—Fe—N-based magnetic powder according to claim 1, wherein the particles forming the powder have an average circularity of 0.80 or more,
wherein the average circularity corresponds to an arithmetic mean of the circularity of each particle determined from an SEM (scanning electron microscope) image by the following formula (2):
$$circularity = 4 Π S / {L}^{2} \qquad ( 2 )$$
where π denotes the circle ratio, S denotes an area of a measurement target particle on the image (μm²), and L denotes a perimeter of the particle on the image (μm).

6. A method for manufacturing the Sm—Fe—N-based magnetic powder according to claim 1, comprising:
a gas atomization step of obtaining an Sm—Fe-based powder in which a molar ratio of Sm to Fe (Sm/Fe) is 0.09 or more and 0.25 or less, and a cumulative 50% particle diameter D50 in a volume-based particle size distribution according to a laser diffraction/scattering method is 25.0 μm or less by a gas atomization method in which, in an atmosphere of an inert gas excluding nitrogen, a gas stream of the inert gas excluding nitrogen is sprayed onto a molten metal containing Sm and Fe as main components, thereby rapidly cooling and solidifying particles of the molten metal;
a classification step of obtaining a powder having a particle size distribution in which a cumulative 10% particle diameter D10, a cumulative 50% particle diameter D50, and a cumulative 90% particle diameter D90 in a volume-based particle size distribution according to a laser diffraction/scattering method satisfy a relationship of the following formula (1) by sieving particles of the powder obtained in the gas atomization step; and
a nitriding step of subjecting the powder obtained in the classification step to a nitriding treatment by heating and holding the powder in a temperature range of 500° C. or lower in a non-oxidizing gas atmosphere containing a nitrogen compound:
$$( D 90 - D 10 ) / D 50 \leq 1.1 . \qquad ( 1 )$$

7. The method for manufacturing the Sm—Fe—N-based magnetic powder according to claim 6, wherein in the gas atomization step, the Sm—Fe-based powder having a Ca content of 0.002 mass % or less is obtained.

8. The method for manufacturing the Sm—Fe—N-based magnetic powder according to claim 6, wherein in the gas atomization step, the Sm—Fe-based powder in which the particles have an average circularity of 0.80 or more is obtained,
wherein the average circularity corresponds to an arithmetic mean of the circularity of each particle determined from an SEM (scanning electron microscope) image by the following formula (2):
$$circularity = 4 Π S / {L}^{2} \qquad ( 2 )$$
wherein π denotes the circle ratio, S denotes an area of a measurement target particle on the image (μm²), and L denotes a perimeter of the particle on the image (μm).

9. The method for manufacturing the Sm—Fe—N-based magnetic powder according to claim 6,
wherein in the classification step, the Sm—Fe-based powder in which, in the volume-based particle size distribution according to a laser diffraction/scattering method, the cumulative 10% particle diameter D10 is 2.0 μm or more and the cumulative 90% particle diameter D90 is 17.0 μm or less is obtained.
